(19) United States
(12) Patent Application Publication
(10) Pub. No.: US 2006/0028311 A1
(43) Pub. Date: Feb. 9, 2006

(54) Electromagnetic actuating device

(76) Inventors: Volker Burger, Emmingen-Liptingen (DE); Hans-Willi Langebahn, Rotgen (DE); Achim Riedle, Steisslingen (DE)

Correspondence Address: STEVEN C. SCHNEDLER;CARTER SCHNEDLER & MONTEITH, PA, 56 CENTRAL AVE., SUITE 101, PO BOX 2985, ASHEVILLE, NC, 28802, US

(21) Appl. No.: 10/529,081

(22) PCT Filed: Jul. 25, 2003
(86) PCT No.: PCT/EP03/08214

§ 371 Date: Mar. 24, 2005

(30) Foreign Application Priority Data
Aug. 2, 2002 (DE) 102 35 644.0

(51) Int. Cl. H01F 7/08

(52) U.S. Cl. 335/229

(57) ABSTRACT

The invention relates to an electromagnetic actuating device, comprising an armature (20) which is provided in a housing (10) in such a way that it can be moved in an axial direction relative to a magnet frame (12) consisting of a core section (14) and a yoke section (18), and a coil device (24) which can be subjected to an electrical current in order to generate the movement, wherein the magnet frame is designed in a hollow-cylindrical manner in such a way that it at least partially surrounds the armature and comprises an intermediate section (16) consisting of non-magnetic material between the core section and the yoke section, wherein a permanent material connection is established in at least one of the cross-over areas (28) between the yoke section and the intermediate section and between the intermediate section and the core section by means of a friction welding method.

### BACKGROUND OF THE INVENTION

The present invention relates to an electromagnetic actuating device including a hollow, cylindrical magnet that has a core section and a yoke section separated by an intermediate section of non-magnetic material.

Such a device as an electromagnetic actuator, for example for use in connection with the control of valves for hydraulic or pneumatic systems or switching applications, is known in a general manner from the prior art. An armature made of magnetic material is movably guided in a magnet frame in order to carry out the essentially linear actuating movement; the magnet frame is surrounded by a coil and is held in a suitably designed housing. By subjecting the coil to electrical current, the armature is then set in the desired motion in order to carry out the actuating movement.

In such electromagnetic actuators, the magnet frame, which is typically elongate, includes a core section and a yoke section. To properly guide or shape the magnetic field, it is necessary for the magnet frame to have an intermediate section consisting of non-magnetic material between the core and yoke sections. The overall magnet frame comprises, as a rotationally symmetrical arrangement, the core section, the intermediate section and the yoke section one after the other. The magnet frame is designed to be hollow-cylindrical, at least in parts, such that the cylindrical armature element can then be guided therein along a longitudinal (movement) axis.

In terms of manufacturing technology, the sequence of core section (consisting of magnetically conductive material), intermediate section (consisting of magnetically non-conductive material) and yoke section (consisting of magnetically conductive material) is not entirely uncritical, as shown by FIG. 1 and the perspective sectional view in FIG. 2 in order to explain the background of the present invention: The rotationally symmetrical magnet frame 12, which is held in a housing 10, is as described divided into three sections (core section 14, intermediate or separating section 16 and yoke section 18) and comprises a hollow-cylindrical cavity for the guidance of an armature element 20. The yoke-side end is furthermore closed by a stop element 22 which is fixedly connected to the magnet frame 12.

As shown in FIG. 1 and FIG. 2, in the housing 10 the magnet frame 12 is also surrounded by a coil 24; a terminal 26 for contacting the coil 24 is shown merely schematically. In FIG. 1, the transition region 28, which is shown as a detailed enlargement in FIGS. 3 and 4, illustrates the difficulties in terms of manufacturing technology when producing the magnet frame 12.

More specifically, an object is to permanently connect the materials of the respective elements 14, 16, 18 to one another in such a way that, on the one hand, the arrangement can cope with the high pressures arising for example in connection with a hydraulic or pneumatic use, but, on the other hand, the geometric profile in the transition region 28 which contributes to the shape of the magnetic field is not adversely affected by the manufacture. More specifically, the design of the connection interfaces between core 14 and intermediate section 16 and between intermediate section 16 and yoke 18 is critical with regard to the magnetic behavior of the arrangement; there is typically a slightly frustoconical end in the region of the end of the core section 14 and/or of the yoke 18, in order to generate there the desired magnetization characteristics.

However, traditional methods for manufacturing the magnet frame 12 consisting of core, intermediate section and yoke lead to undesirable deformations of the geometric profile at the critical transition region 28, as shown in FIG. 3 in respect of a conventional manufacturing process. More specifically, in known manufacturing methods according to the prior art, the annular intermediate section 16 is applied to the ends of core 14 and yoke 18 by hard facing welding (build-up welding), typically by means of so-called MIG (metal inert gas) welding using a CuAl alloy as non-magnetic material to be welded on as the intermediate section 16. Prior to build-up welding, the end sections of yoke 18 and 14 have the frustoconical profiles shown for example in FIG. 4.

However, in the case of droplet-based MIG hard facing welding, on account of the very high arc temperatures there is the risk that the frustoconical profiles will be significantly changed thereby, as can be seen in FIG. 3. The profile, which was originally a straight line in cross section, is now wavy (in an undefined and largely random manner), so that the magnetic characteristic at the critical connection interface is affected in the region of the intermediate section 16 in an unpredictable way.

A further disadvantage is that an increased number of cavities and pores are produced by the MIG hard facing welding process. These give rise to the risk of lack of sealing in the region of the intermediate section 16, and also to the risk of a fatigue fracture of the magnet frame.

A further disadvantage of the conventional manufacturing method summarized above is that relatively long process times of typically approximately 30 seconds are required for the hard facing welding (build-up welding) process. This in turn has a disadvantageous effect on the manufacturing time and thus on the manufacturing costs, since on the other hand, however, the penetration of heat into the welded joint is limited by the frustoconical geometry which has to be retained, and this process time cannot be further reduced, at least not without adversely affecting the connection interface geometry, cf. FIG. 3.

A further disadvantage in terms of manufacturing outlay which is caused by the known technology is that, during the hard facing welding (build-up welding) operation, adjacent component parts are adversely affected by welding sprayers, and thus additional outlay in terms of protective covering is required. Added to this is the fact that applied material for the area 16 has to be machined in order to produce the cylindrical outer and inner shape, and this accordingly entails further outlay.

Finally, another disadvantage of the conventional method is that the non-magnetic additional material for the intermediate section 16 is relatively expensive in terms of wire dimensions (since the operations of roughing-down and annealing to a small diameter entail a significant outlay in terms of manufacture).

### SUMMARY OF THE INVENTION

It is therefore an object of the present invention to provide a generic electromagnetic actuator which on the one hand is improved with regard to its predefined electromagnetic properties at the connections or interfaces between core and non-magnetic intermediate section and between intermediate section and yoke, and on the other hand is simplified with regard to its manufacture, in particular in terms of the outlay associated with its manufacture, and in particular allows the manufacture of electromagnetic actuating devices at a lower cost.

In one embodiment of the invention, at least one of the connections between the yoke section and the intermediate section or between the intermediate section and the core section is produced by friction welding; embodiments of the invention also include the case in which the yoke section and the intermediate section are formed in one piece from non-magnetic material and thus there is only one connection produced by friction welding.

The friction welding method embodying the invention has the advantage that the contacting surfaces heat up in such a way that the material of the non-magnetic intermediate section in particular becomes plastic but does not, however, as in the case of arc welding, become fluid. Thus, by employing an appropriate compression force, a reliable weld can be produced. Although the weld has the required high strength, at the same time it leaves the geometry predefined by the core and yoke end sections unchanged, for example the selected frustoconical geometry, and thus the shape of the magnetic field determined thereby can be calculated and remains unchanged. By virtue of the plastic, rather pasty state of the materials of the joint, cavities and pores can moreover arise only to a very limited extent, unlike in the case of hard facing welding; moreover, since the effect takes place over the entire surface, the inhomogeneities of the droplet-based hard facing welding (build-up welding) method are avoided.

A further advantage of this friction welding method is that considerably less time is required for the welding operation, typically approximately 10 to 15 seconds and thus the manufacturing process also becomes more rapid and efficient.

A further advantage is that the non-magnetic material for the intermediate section can now be supplied and used as tubular stock material and thus in a significantly more cost-effective manner than wire material. Moreover, it has been found that a more cost-effective material quality can be used for the intermediate section 16.

As a result, embodiments of the invention thus provide, in a surprisingly simple manner, a manufacturing process for electromagnetic actuators which is based on the principle of friction welding and makes the manufacture much simpler and less expensive, and as a result of which magnetic properties, the quality of the connections and the load properties of the resulting end product are moreover considerably improved.

In a preferred manner according to one embodiment it is provided that at least one of yoke section or core section has a frustoconical profile at its end facing the intermediate section. This ensures that a particularly favorable guide for the magnetic field exists at the connection interfaces to the intermediate section and thus the magnetic properties, on account of the teaching of the use of friction welding according to the invention, are particularly useful.

On the one hand, it is favorable to design the shape of the intermediate section in a correspondingly frustoconical manner as a mating element for the friction welding. Alternatively, the facing end section of the intermediate section may be designed to be flat. It has surprisingly been found that in this case too friction welding leads to an extremely advantageous connection interface between the materials, which connection interface virtually does not change the original geometry.

While on the one hand it is possible and preferable to join in each case one of the connection mating elements (yoke section or core section) for example on either side of the annular intermediate section by virtue of the advantageous friction welding method according to the invention, and even more preferably to do this simultaneously in one common operation, it is likewise within the scope of the invention to carry this out in successive operating steps, or to limit it to one connection interface.

Since the present invention gives rise, in a particularly reliable and mechanically stable manner, to a connection interface between the connection mating elements which is low in cavities and pores, and thus the risk of lack of sealing is minimized, the present invention is particularly preferably suitable for electromagnetic actuating devices which are used in connection with hydraulic or pneumatic valves, and in particular in high-pressure applications of up to several hundred bar, as arise for example in many applications of stationary and mobile hydraulics. However, the present invention together with its advantages is not limited to such applications.

### BRIEF DESCRIPTION OF THE DRAWINGS

Further advantages, features and details of the present invention emerge from the following description of preferred examples of embodiments and with reference to the drawings, in which:

FIG. 1 is a sectional view through the electromagnetic actuating device according to the present invention to illustrate the advantages of the invention compared to the prior art;

FIG. 2 is a three-dimensional view corresponding to FIG. 1;

FIG. 3 is an enlarged representation of the transition region 28 in FIG. 1 according to the prior art, with the geometrical profile deformed by welding;

FIG. 4 is a view analogous to FIG. 3 following the friction welding of the present invention, with a non-deformed frustoconical profile;

FIG. 5 is an exploded diagram of the mating elements—core, intermediate section, yoke—according to a first embodiment of the invention, prior to joining by the friction welding method;

FIG. 6 is a diagram analogous to FIG. 5 showing a second embodiment of the invention, with a different geometric profile in the intermediate section; and

FIG. 7 shows the arrangement of FIGS. 5, 6 after joining by friction welding.

### DETAILED DESCRIPTION

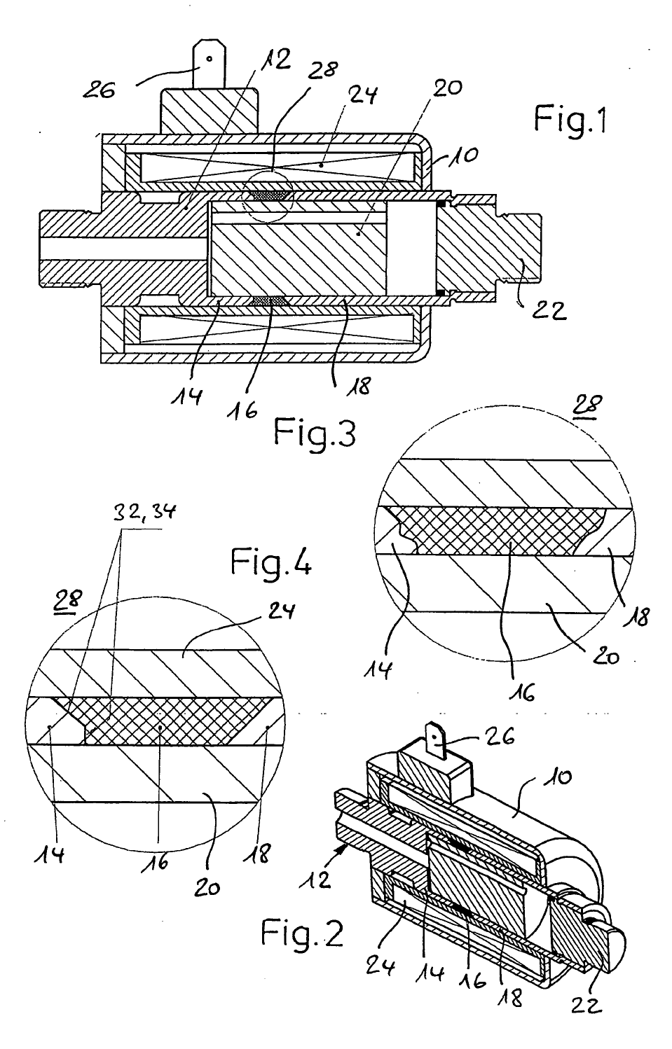

Based on the schematic representation described above of an electromagnetic actuator as shown in FIG. 1, FIG. 2 and the problems of deformation of the (in this case originally frustoconical) core and yoke geometry following application of the intermediate section 16 by hard facing welding (build-up welding), FIG. 4 shows, analogously to the diagram in FIG. 3, that as a result of the friction welding method the core-side frustoconical geometry comprising frustoconical section 32 and flat annular section 34 and the pure frustoconical shape of the yoke section 18 remain virtually non-deformed and thus unchanged, and thus the originally determined magnetic properties predefined by the frustoconical shape are fully retained. (In FIG. 4, the frustoconical profile of section 32 merges in a truncated manner into the flat annular section 34, which lies in a plane perpendicular to the axial direction.)

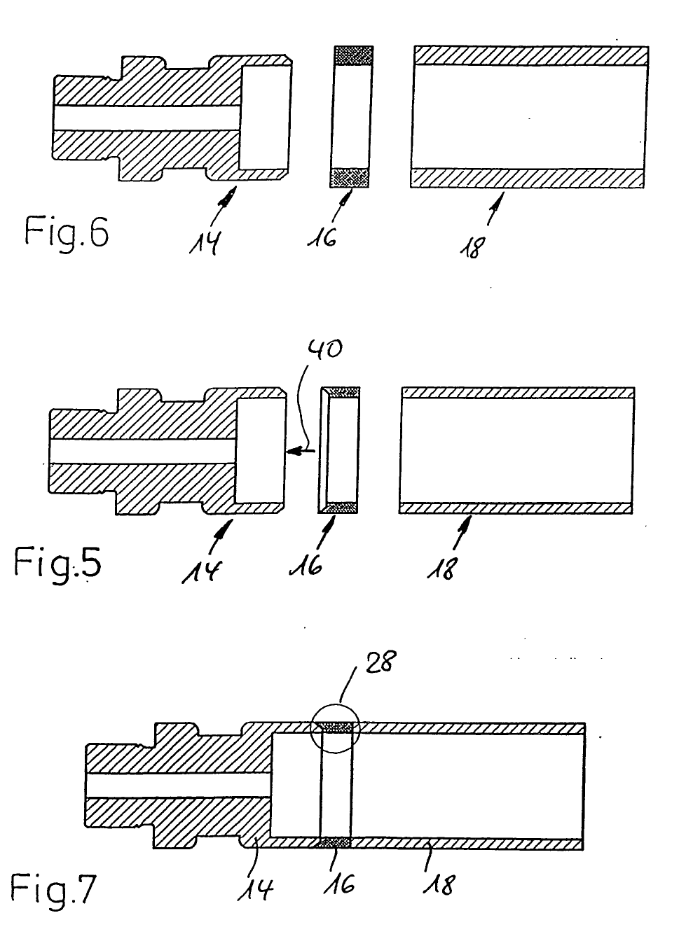

Specifically, in the example of embodiment shown, the core 14 was rotated at a rotational velocity of between 1500 and 2500 revolutions per minute and a ring 16 of CuAl alloy having a suitably adapted, negative frustoconical shape (FIG. 5) was pressed on in the direction of the arrow 40 with a pressure of between approximately 50 and 250 N/mm². By virtue of the considerable heating, the contacting surfaces heat up. As soon as the non-magnetic material (the CuAl alloy; alternatively other alloys, such as an Al alloy for example, are also conceivable) is plastic, rotation of the core 14 is stopped and, with an additional compression force (typically 80 to 300 N/mm²), the two parts are pressed together and thus welded.

Following cooling and undercutting or twisting of the bead produced by the friction welding, a strong, cavity-free and pore-free joint is obtained with a frustoconical geometry which remains virtually unchanged, as can be seen from FIG. 4.

Immediately thereafter, using the same method, the yoke 18 can for example be friction-welded to the assembly consisting of core 14 and intermediate section 16; the result is shown in FIG. 7.

An alternative embodiment is illustrated with reference to FIG. 6. In this case, with a thicker yoke wall diameter, the ring to be used as intermediate element does not have a negative frustoconical profile in the direction of the core 14. However, the same contour-true joint geometry as shown in FIG. 4 is produced as a result of the process.

It is also not ruled out that, by way of modification to FIGS. 5 to 7, for example the intermediate section 16 and/or the yoke section 18 are connected by friction welding as solid material (instead of as tubular material as shown in the figures) and then correspondingly machined.

The present invention is not restricted to the described embodiments of metallurgical compositions (for instance, in principle, for the friction welding method and as a material for the intermediate section 16, any non-magnetic, metallic or non-metallic material would be suitable—for example plastics or ceramic); different superstructures, procedures or operating parameters are also conceivable.

1. An electromagnetic actuator, comprising:
an armature movable in an axial direction relative to a magnet frame including a core section and a yoke section;
a coil which can be electrically energized to move said armature;
said magnet frame being hollow-cylindrical in configuration and at least partially surrounding said armature, said magnet frame including an intermediate section comprising non-magnetic material between said core section and said yoke section, there being a first connection interface between said yoke section and said intermediate section and a second connection interface between said intermediate section and said yoke section; and
at least one of the connection interfaces comprising a friction weld.

2. The actuator of claim 1, wherein at least one of said yoke section and said core section has a frustoconical profile at an end facing said intermediate section.

3. The actuator of claim 2, wherein the frustoconical profile merges in a truncated manner into a flat annular section which lies in a plane perpendicular to the axial direction.

4. The actuator of claim 1, wherein said intermediate section is designed as a tubular element which, at an end facing said yoke section, said core section, or both, has a frustoconical profile adapted to the respective end of said yoke section or core section.

5. The actuator of claim 1, wherein said intermediate section is designed as a tubular element which, at an end facing said yoke section, said core section, or both, is flat and adapted to the respective end of said yoke section or core section.

6. The actuator of claim 1, wherein said yoke section and said intermediate section are formed in one piece from non-magnetic material.

7. A method for manufacturing a magnet frame for an electromagnetic actuator, the magnet frame including a core section, a yoke section and a non-magnetic intermediate section between the core and yoke sections, by making a permanent connection between the core section and the intermediate section as mating elements of a first connection interface and between the yoke section and the intermediate section as mating elements of a second connection interface, said method comprising:
rotating one of the mating elements of the first connection interface, the second connection interface, or both;
pressing the respective other mating element of the first or second connection interface against the rotating mating element to effect frictional heating which plasticizes the surface of the intermediate section pressed against the surface of the core section or the yoke section;
stopping the rotation; and
pressing the mating elements against one another to produce a welded connection interface.

8. The method as claimed in claim 7, which comprises producing the first connection interface and the second connection interface at the same time.

9. The method as claimed in claim 7, which comprises producing the first connection interface and the second connection interface sequentially.

10. The method claim 7, which comprises rotating one of the mating elements of the first connection interface, the second connection interface, or both at a rotational velocity within a range between 1500 and 2500 revolutions per minute; wherein
pressing takes place with a pressure of between 50 and 250 N/mm²; and wherein
the mating elements are pressed against one another with a compression force within a range between 80 and 300 N/mm².

11. (canceled)

12. The actuator of claim 2, wherein said intermediate section is designed as a tubular element which, at an end facing said yoke section, said core section, or both, has a frustoconical profile adapted to the respective end of said yoke section or core section.

13. The actuator of claim 3, wherein said intermediate section is designed as a tubular element which, at an end facing said yoke section, said core section, or both, has a frustoconical profile adapted to the respective end of said yoke section or core section.

14. The actuator of claim 2, wherein said intermediate section is designed as a tubular element which, at an end facing said yoke section, said core section, or both, is flat and adapted to the respective end of said yoke section or core section.

15. The actuator of claim 3, wherein said intermediate section is designed as a tubular element which, at an end facing said yoke section, said core section, or both, is flat and adapted to the respective end of said yoke section or core section.

16. The method claim 8, which comprises rotating one of the mating elements of the first connection interface, the second connection interface, or both at a rotational velocity within a range between 1500 and 2500 revolutions per minute; wherein
pressing takes place with a pressure of between 50 and 250 N/mm²; and wherein
the mating elements are pressed against one another with a compression force within a range between 80 and 300 N/mm².

17. The method claim 9, which comprises rotating one of the mating elements of the first connection interface, the second connection interface, or both at a rotational velocity within a range between 1500 and 2500 revolutions per minute; wherein
pressing takes place with a pressure of between 50 and 250 N/mm²; and wherein
the mating elements are pressed against one another with a compression force within a range between 80 and 300 N/mm².
